(19) United States
(12) Patent Application Publication
(10) Pub. No.: US 2011/0094212 A1
(43) Pub. Date: Apr. 28, 2011

(54) COMPRESSED AIR ENERGY STORAGE SYSTEM WITH REVERSIBLE COMPRESSOR-EXPANDER UNIT

(76) Inventors: Gabor Ast, Garching (DE); Stephanie Marie-Noelle Hoffmann, Muenchen (DE); Matthew Lehar, Munich (DE); Alexander Simpson, Munich (DE); Christian Aalburg, München (DE); Thomas Frey, Regensburg (DE); Matthias Finkenrath, Garching b. Muenchen (DE); Richard Aumann, Muenchen (DE)

(21) Appl. No.: 12/607,262

(22) Filed: Oct. 28, 2009

(51) Int. Cl. F02C 6/16; F02C 7/00

(52) U.S. Cl. 60/327; 60/415; 60/331

(57) ABSTRACT

A system and method for compressing and expanding air in a compressed air energy storage (CAES) system is disclosed. A CAES system is provided that is alternately operable in a compression mode and an expansion mode and includes therein a motor-generator unit and a drive shaft connected to the motor-generator unit that is configured to transmit rotational power to and from the motor-generator unit. The CAES system also includes at least one reversible compressor-expander unit coupled to the drive shaft and configured to selectively compress and expand air, and an air storage unit connected to the reversible compressor-expander unit and configured to store compressed air received therefrom, with the at least one reversible compressor-expander unit compressing air during the compression mode and expanding air during the expansion mode.

### BACKGROUND OF THE INVENTION

Embodiments of the invention relate generally to compressed air energy storage (CAES) systems and, more particularly, to a CAES system having an air compression and expansion system that includes reversible compressor-expander units for compressing and expanding air during compression and expansion modes of operation.

Air compression and expansion systems are used in a multitude of industries for a variety of applications. For example, one such application is the use of air compression and expansion systems as the turbomachinery in generating and storing energy. Compressed air energy storage (CAES) systems typically include a compression train having a plurality of compressors that compress intake air and provide the compressed intake air to a cavern, underground storage, or other compressed air storage component. The compressed air is then later used to drive turbines to produce energy such as, for example, electrical energy. During operation of the compression stage of a CAES system, the compressed intake air is typically cooled. During operation of the expansion stage, air is discharged from underground storage through turbines and expands such that the air exits the turbines at ambient pressure.

Typically, compressors and turbines in CAES systems are each connected to a generator/motor device through respective clutches, permitting operation either solely of the compressors or solely of the turbines during appropriate selected time periods. During off-peak periods of electricity demand in the power grid (i.e., nights and weekends), the compressor train is driven through its clutch by the generator/motor. In this scheme, the generator/motor functions as a motor, drawing power from a power grid. The compressed air is then cooled and delivered to underground storage. During peak demand periods, with the turbine clutch engaged, air is withdrawn from storage and then heated and expanded through a turbine train to provide power by driving the generator/motor. In this scheme, the generator/motor functions as a generator, providing power to a power grid, for example.

A typical arrangement of air compression and expansion system in a CAES system 100 as known in the prior art is shown in FIG. 1. The air compression and expansion system 101 is configured to alternately operate in a compression mode and an expansion mode and includes a combined motor-generator unit 102, drive shafts 104, 106, clutches 108, 110, a compressor system 112, and a turbine system 114.

Motor-generator unit 102 is electrically connected to a baseload power supply via a power transmission line, and receives power therefrom during the compression mode of operation. During operation in the compression mode, motor-generator unit 102 generates rotational power that is transmitted to compressor system 112 by way of drive shaft 104. Clutch 108 is engaged to couple the compressor system 112 to the drive shaft 104 and motor-generator unit 102, thereby driving the compressor system 112 to compress air that is stored for subsequent power generation.

Upon switching of air compression and expansion system 101 to the expansion mode of operation, the supply of power to motor-generator unit 102 is terminated such that the transfer of rotational power to drive shaft 104 is terminated and compressor system 112 is no longer powered. Clutch 110 is then engaged to couple turbine system 114 to drive shaft 106 and motor-generator unit 102, allowing for power to be transferred from turbine system 114 to motor-generator unit 102. Upon delivery of the stored compressed air to turbine system 114, rotational power is provided from turbine system 114, which is transferred to motor-generator unit 102 by way of drive shaft 106.

While the inclusion of drive shafts 104, 106, clutches 108, 110, compressor system 112, and turbine system 114 in air compression and expansion system 101 functions to generate power, it is not without its drawbacks. For example, the arrangement of multiple drive shafts 104, 106 and clutches 108, 110 requires many components and much space. Furthermore, the use of separate compressor and turbine systems increases the downtime of such units, as they are each only operable during a single mode of operation of the CAES system 100 (i.e., either the compression or expansion mode of operation). Thus, with the arrangement of the compressor system 112, and turbine system 114 in CAES system 100, an increase in capital expenditures, operating expenditures, and system footprint is realized, along with a decrease in operational efficiency.

Therefore, it would be desirable to design a system and method that overcomes the aforementioned drawbacks.

### BRIEF DESCRIPTION OF THE INVENTION

Embodiments of the invention provide a system and method for compressing and expanding air in a compressed air energy storage (CAES) system. The CAES system includes an air compression and expansion system having reversible compressor-expander units for compressing and expanding air. The reversible compressor-expander units function as compressors during a compression mode of operation and alternately function as expanders during an expansion mode of operation.

In accordance with one aspect of the invention, a compressed air energy storage (CAES) system is alternately operable in a compression mode and an expansion mode and includes a motor-generator unit and a drive shaft connected to the motor-generator unit configured to transmit rotational power to and from the motor-generator unit. The CAES system also includes at least one reversible compressor-expander unit coupled to the drive shaft and configured to selectively compress and expand air and an air storage unit connected to the reversible compressor-expander unit and configured to store compressed air received therefrom, with the at least one reversible compressor-expander unit compressing air during the compression mode and expanding air during the expansion mode.

In accordance with another aspect of the invention, a method for compressing and expanding gas in a compressed air energy storage (CAES) system includes the step of providing rotational power to a reversible compressor-turbine unit during a compression stage of operation, with the rotational power being provided to the reversible compressor-turbine unit from a combined motor-generator unit and by way of a drive shaft. The method also includes the steps of compressing air in the reversible compressor-turbine unit during the compression stage of operation in response to the rotational power, storing the compressed air in an air storage unit for a desired period of time, transferring the compressed air from the air storage unit to the reversible compressor-turbine unit during an expansion stage of operation, and expanding the compressed air in the reversible compressor-turbine unit during the expansion stage of operation, with the reversible compressor-turbine unit being driven by the transferred compressed air. The method further includes the step of transferring the rotational power generated by the reversible compressor-turbine unit during the expansion stage of operation to the combined motor-generator unit by way of the drive shaft, thereby causing the combined motor-generator unit to generate electric power.

In accordance with yet another aspect of the invention, a compressed air energy storage (CAES) system is alternately operable in a compression mode and an expansion mode and includes a combined motor-generator unit configured to both generate mechanical power and electrical power and a drive shaft connected to the motor-generator unit and configured to transmit rotational power to and from the motor-generator unit. The CAES system also includes a reversible compressor-expander unit fixedly coupled to the drive shaft and an air storage unit connected to the reversible compressor-expander unit and configured to store compressed air received therefrom. The reversible compressor-expander unit is coupled to the drive shaft without use of a clutch such that the reversible compressor-expander unit operates to compress air during the compression mode and expand air during the expansion mode.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a block schematic diagram of a compressed air energy storage (CAES) system as known in the prior art.

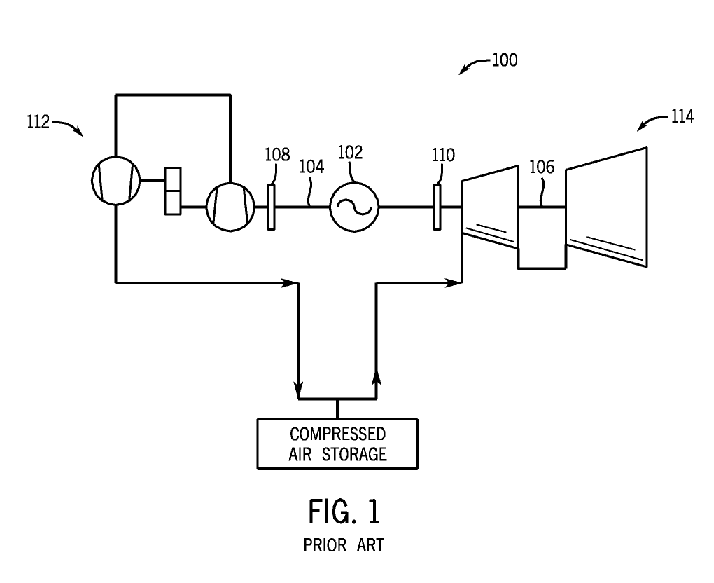

FIG. 2 is a block schematic diagram of a CAES system according to an embodiment of the present invention.

FIG. 3 is a block schematic diagram of an adiabatic CAES system according to an embodiment of the present invention.

### DETAILED DESCRIPTION

According to embodiments of the invention, a compressed air energy storage (CAES) system is provided having an air compression and expansion system that includes reversible compressor-expander units for compressing and expanding air. The reversible compressor-expander units function as compressors during a compression mode of operation and alternately function as expanders during an expansion mode of operation.

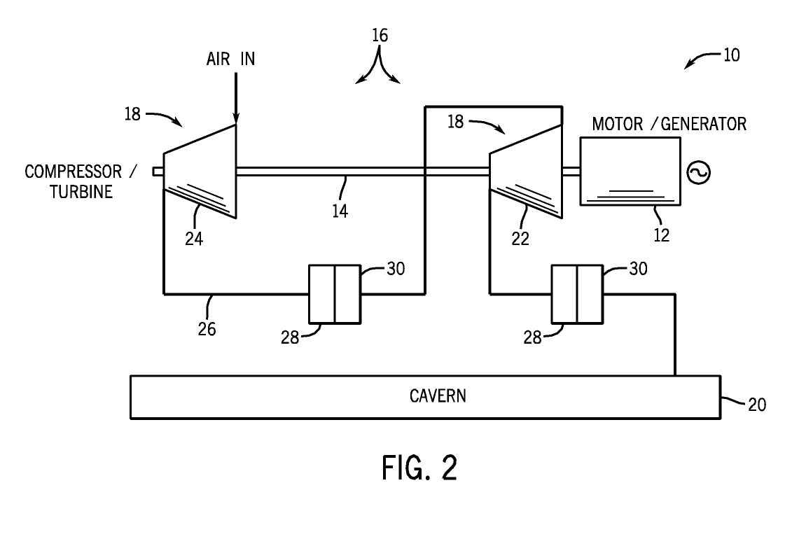

Referring to FIG. 2, a CAES system 10 is shown according to an embodiment of the invention. The CAES system 10 is configured to alternately operate in a compression mode and an expansion mode as determined by an operator, so as to selectively produce energy such as, for example, electrical energy. The CAES system 10 includes a combined motor-generator unit 12, a drive shaft 14, an air compression and expansion system 16 that includes one or more reversible compressor-expander units 18, and an air storage unit or cavern 20.

As shown in FIG. 2, air compression and expansion system 16 includes two compressor-expander units 18, such that the air compression and expansion system 16 is configured as a two-stage compression and expansion system. It is recognized, however, that that the air compression and expansion system 16 could include a greater or lesser number of compressor-expander units 18. Thus, for example, air compression and expansion system 16 could be in the form of a single stage system having only one compressor-expander unit 18 or, alternatively, air compression and expansion system 16 could be in the form of a three-stage system having three compressor-expander units 18. Embodiments of the invention could thus include any number of compressor-expander units 18, as desired according to design considerations of the CAES system 10.

Each of the reversible compressor-expander units 18 is configured to alternately compress air and expand air during respective compression and expansion modes of operation of the CAES system 10. That is, reversible compressor-expander units 18 are configured to operate as compressors when driven by motor-generator unit 12 and drive shaft 14 during the compression mode of operation and are configured to operate as expanders when supplied with compressed air from the air storage unit 20 during the expansion mode of operation. As such, compressor-expander units 18 are in operation during each of the compression and expansion modes of operation. Beneficially, the frequent operation of the compressor-expander units 18 reduces issues related to unit start-up, as the units are nearly always “warm.”

As reversible compressor-expander units 18 are in operation during each of the compression and expansion modes of operation, the compressor-expander units are coupled to drive shaft 14 in a clutch-less arrangement. No clutch is needed to selectively couple and decouple reversible compressor-expander units 18 to drive shaft 14, as the units 18 are configured to operate as compressors when driven by motor-generator unit 12 and drive shaft 14 during the compression mode of operation and are configured to operate as expanders when supplied with compressed air from the air storage unit 20 during the expansion mode of operation. The clutch-less arrangement provided by reversible compressor-expander units 18 thus simplifies operation of air compression and expansion system 16 in CAES system 10, lowering capital expenditure and operating expenditure costs associated with the air compression and expansion system 16, such as unit production cost, maintenance cost, etc. The use of reversible compressor-expander units 18 in air compression and expansion system 16 also reduces the overall footprint of the system as compared to a system including separate compressor and turbine units.

According to embodiments of the invention, the reversible compressor-expander units 18 may take one of a number of forms. For example, reversible compressor-expander units 18 may be configured as radial-type compressor-expander units or axial-type compressor-expander units. Reversible compressor-expander units 18 may also be configured as screw-type compressor-expander units or piston-type compressor-expander units. The reversible compressor-expander units 18 included in CAES system 10 are sized to accommodate power generation in the range of approximately 200-300 MW.

Referring still to FIG. 2, during the compression mode of operation of CAES system 10, motor-generator unit 12 is electrically connected to a baseload power source (not shown) so as to receive power therefrom. The input of electrical power causes motor-generator unit 12 to operate in a motor mode, thereby generating a mechanical output of rotational power in response to the electrical power. The rotational power is transferred to drive shaft 14, thus causing the drive shaft to rotate. Compressor-expander units 18 are thus driven by the rotational power to compress air supplied thereto. According to the embodiment of FIG. 2, air is compressed to a low pressure by a first compressor-expander unit 22 and subsequently passed along to a second compressor-expander unit 24 by way of a compression-expansion path 26 fluidly connecting the units. The air is further compressed to a high pressure by second compressor-expander unit 24 and is then transferred through compression-expansion path 26 to air storage unit 20 for later use.

According to the present embodiment, before the compressed air is stored in air storage unit 20, it is passed through a number of cooling units 28 that remove heat from the compressed air prior to storage of the cavern. A cooling unit 28 is positioned downstream from each of the first and second compressor-expander units 22, 24, so as to cool the air after each stage of compression.

When it is desired for CAES system 10 to operate in an expansion mode of operation, electrical power to motor-generator unit 12 is terminated, and air is retrieved from air storage unit 20 for expansion. The previously compressed air retrieved from storage unit 20 is provided to compression-expansion path 26 and passes therethrough to second compressor-expander unit 24. The compressed air causes second compressor-expander unit 24 to act as an expander/turbine, and the air is thus expanded from a high pressure to a lower pressure (i.e., a “low” pressure) by second compressor-expander unit 24. The air then continues to pass through compression-expansion path 26 to be received by first compressor-expander unit 22. First compressor-expander unit 22 is driven by the low pressure compressed air and functions as an expander/turbine to further expand the air. The expansion of the compressed air in each of the first and second compressor-expander units 22, 24 generates rotational power. The rotational power is transferred to drive shaft 14, which receives the rotational power and transfers this power to motor-generator unit 12. The motor-generator unit 12 operates in a generator mode during the expansion mode of operation, and thus generates electrical power in response to the received rotational power output from turbine system 22.

According to the present embodiment, before the compressed air is expanded by the first and second compressor-expander units 22, 24, it is passed through a number of heating units or combustors 30 that add heat to the compressed air. A heating unit 30 is positioned upstream from each of the first and second compressor-expander units 22, 24, so as to heat the compressed air prior to each stage of expansion.

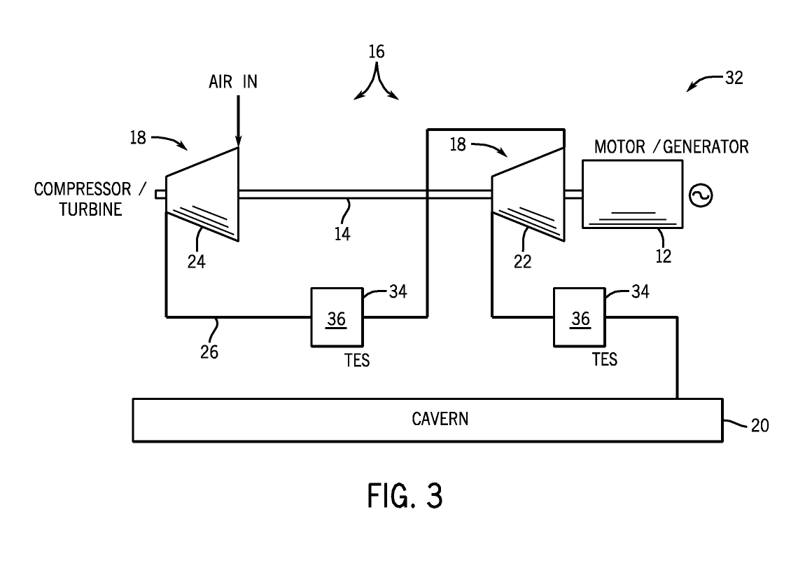

Referring now to FIG. 3, a block schematic diagram of an adiabatic compressed air energy storage (ACAES) system 32 is shown according to an embodiment of the invention. The ACAES system 32 is configured to alternately operate in a compression mode and an expansion mode as determined by an operator, so as to selectively produce energy such as, for example, electrical energy. The ACAES system 32 includes a combined motor-generator unit 12, a drive shaft 14, an air compression and expansion system 16 that includes one or more reversible compressor-expander units 18, an air storage unit or cavern 20, and one or more thermal energy storage (TES) units 34 for heating and cooling air during the compression and expansion modes of operation.

As shown in FIG. 3, air compression and expansion system 16 includes two compressor-expander units 18, such that the air compression and expansion system 16 is configured as a two-stage compression and expansion system. It is recognized, however, that that the air compression and expansion system 16 could include a greater or lesser number of compressor-expander units 18. Each of the reversible compressor-expander units 18 is configured to alternately compress air and expand air during respective compression and expansion modes of operation of the ACAES system 32. That is, reversible compressor-expander units 18 are configured to operate as compressors when driven by motor-generator unit 12 and drive shaft 14 during the compression mode of operation and are configured to operate as expanders when supplied with compressed air from the air storage unit 20 during the expansion mode of operation. As such, compressor-expander units 18 are in operation during each of the compression and expansion modes of operation.

During the compression mode of operation of ACAES system 32, motor-generator unit 12 is electrically connected to a baseload power source (not shown) so as to receive power therefrom. The input of electrical power causes motor-generator unit 12 to operate in a motor mode, thereby generating a mechanical output of rotational power in response to the electrical power. The rotational power is transferred to drive shaft 14, thus causing the drive shaft to rotate. Compressor-expander units 18 are thus driven by the rotational power to compress air supplied thereto. According to the embodiment of FIG. 3, air is compressed to a low pressure by a first compressor-expander unit 22 and subsequently passed along to a second compressor-expander unit 24 by way of a compression-expansion path 26 fluidly connecting the units. The air is further compressed to a high pressure by second compressor-expander unit 24 and is then transferred through compression-expansion path 26 to air storage unit 20 for later use.

Also during the compression mode of operation of ACAES system 32, air is passed through a TES unit 34 after each stage of compression. The TES units 34 function to cool (i.e., remove heat) the air passing through the compression-expansion path during the compression mode of operation. The TES units 34 include therein a thermal fill 36 that is composed of a heat storage material of sufficient quantity to store the heat of compression generated during the compression stage prior to storage in air storage unit 20, with the stored heat being later conveyed back to the compressed air during the expansion stage/mode of operation of ACAES system 32.

During the expansion mode of operation, air is retrieved from air storage unit 20 for expansion. The previously compressed air retrieved from storage unit 20 is provided to compression-expansion path 26 and passes therethrough to second compressor-expander unit 24. The compressed air causes second compressor-expander unit 24 to act as an expander/turbine, and the air is thus expanded from a high pressure to a lower pressure (i.e., a “low” pressure) by second compressor-expander unit 24. The air then continues to pass through compression-expansion path 26 to be received by first compressor-expander unit 22. First compressor-expander unit 22 is driven by the low pressure compressed air and functions as an expander/turbine to further expand the air. The expansion of the compressed air in each of the first and second compressor-expander units 22, 24 generates rotational power. The rotational power is transferred to drive shaft 14, which receives the rotational power and transfers this power to motor-generator unit 12. The motor-generator unit 12 operates in a generator mode during the expansion mode of operation, and thus generates electrical power in response to the received rotational power output from turbine system 22.

Also during the expansion mode of operation of ACAES system 32, air is passed through a TES unit 34 prior to each stage of expansion. The TES units 34 function to heat the air passing through the compression-expansion path 26 during the expansion mode of operation. The heat stored in TES units 34 generated during the compression mode of operation is added back to the compressed air as it passes back therethrough during the expansion mode of operation of ACAES system 32.

Therefore, according to one embodiment of the invention, a compressed air energy storage (CAES) system is alternately operable in a compression mode and an expansion mode and includes a motor-generator unit and a drive shaft connected to the motor-generator unit configured to transmit rotational power to and from the motor-generator unit. The CAES system also includes at least one reversible compressor-expander unit coupled to the drive shaft and configured to selectively compress and expand air and an air storage unit connected to the reversible compressor-expander unit and configured to store compressed air received therefrom, with the at least one reversible compressor-expander unit compressing air during the compression mode and expanding air during the expansion mode.

According to another embodiment of the invention, a method for compressing and expanding gas in a compressed air energy storage (CAES) system includes the step of providing rotational power to a reversible compressor-turbine unit during a compression stage of operation, with the rotational power being provided to the reversible compressor-turbine unit from a combined motor-generator unit and by way of a drive shaft. The method also includes the steps of compressing air in the reversible compressor-turbine unit during the compression stage of operation in response to the rotational power, storing the compressed air in an air storage unit for a desired period of time, transferring the compressed air from the air storage unit to the reversible compressor-turbine unit during an expansion stage of operation, and expanding the compressed air in the reversible compressor-turbine unit during the expansion stage of operation, with the reversible compressor-turbine unit being driven by the transferred compressed air. The method further includes the step of transferring the rotational power generated by the reversible compressor-turbine unit during the expansion stage of operation to the combined motor-generator unit by way of the drive shaft, thereby causing the combined motor-generator unit to generate electric power.

According to yet another embodiment of the invention, a compressed air energy storage (CAES) system is alternately operable in a compression mode and an expansion mode and includes a combined motor-generator unit configured to both generate mechanical power and electrical power and a drive shaft connected to the motor-generator unit and configured to transmit rotational power to and from the motor-generator unit. The CAES system also includes a reversible compressor-expander unit fixedly coupled to the drive shaft and an air storage unit connected to the reversible compressor-expander unit and configured to store compressed air received therefrom. The reversible compressor-expander unit is coupled to the drive shaft without use of a clutch such that the reversible compressor-expander unit operates to compress air during the compression mode and expand air during the expansion mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A compressed air energy storage (CAES) system alternately operable in a compression mode and an expansion mode, the CAES system comprising:
a motor-generator unit;
a drive shaft connected to the motor-generator unit and configured to transmit rotational power to and from the motor-generator unit;
at least one reversible compressor-expander unit coupled to the drive shaft and configured to selectively compress and expand air; and
an air storage unit connected to the reversible compressor-expander unit and configured to store compressed air received therefrom;
wherein the at least one reversible compressor-expander unit compresses air during the compression mode and expands air during the expansion mode.

2. The CAES system of claim 1 wherein the reversible compressor-expander unit is configured to operate as a compressor when driven by the drive shaft.

3. The CAES system of claim 1 wherein the reversible compressor-expander unit is configured to operate as an expander when supplied with compressed air from the air storage unit.

4. The CAES system of claim 1 wherein the reversible compressor-expander unit comprises a radial-type compressor-expander unit.

5. The CAES system of claim 1 wherein the reversible compressor-expander unit comprises an axial-type compressor-expander unit.

6. The CAES system of claim 1 wherein the reversible compressor-expander unit comprises a screw-type compressor-expander unit.

7. The CAES system of claim 1 wherein the reversible compressor-expander unit comprises a piston-type compressor-expander unit.

8. The CAES system of claim 1 wherein the at least one reversible compressor-expander unit comprises:
a first reversible compressor-expander unit; and
a second reversible compressor-expander unit;
wherein the first and second reversible compressor-expander units are fluidly connected by a compression-expansion path to form a two-stage compression expansion system.

9. The CAES system of claim 1 further comprising at least one thermal energy storage (TES) unit, such that the CAES system is configured as an adiabatic CAES system.

10. The CAES system of claim 1 wherein at least one reversible compressor-expander unit is fixedly coupled to the drive shaft in a clutch-less arrangement.

11. A method for compressing and expanding gas in a compressed air energy storage (CAES) system comprising:
providing rotational power to a reversible compressor-turbine unit during a compression stage of operation, the rotational power being provided to the reversible compressor-turbine unit from a combined motor-generator unit and by way of a drive shaft;
compressing air in the reversible compressor-turbine unit during the compression stage of operation in response to the rotational power;
storing the compressed air in an air storage unit for a desired period of time;
transferring the compressed air from the air storage unit to the reversible compressor-turbine unit during an expansion stage of operation;
expanding the compressed air in the reversible compressor-turbine unit during the expansion stage of operation, the reversible compressor-turbine unit being driven by the transferred compressed air; and
transferring the rotational power generated by the reversible compressor-turbine unit during the expansion stage of operation to the combined motor-generator unit by way of the drive shaft, thereby causing the combined motor-generator unit to generate electric power.

12. The method of claim 11 wherein compressing air in the reversible compressor-turbine unit comprises compressing air in a radial-type compressor-expander unit.

13. The method of claim 11 wherein compressing air in the reversible compressor-turbine unit comprises compressing air in an axial-type compressor-expander unit.

14. The method of claim 11 wherein compressing air in the reversible compressor-turbine unit comprises compressing air in a screw-type compressor-expander unit.

15. The method of claim 11 wherein compressing air in the reversible compressor-turbine unit comprises compressing air in a piston-type compressor-expander unit.

16. The method of claim 11 wherein compressing and expanding air in the reversible compressor-turbine unit comprises:
compressing and expanding air in a first reversible compressor-expander unit during the compression stage and the expansion stage of operation, respectively; and
compressing and expanding air in a second reversible compressor-expander unit during the compression stage and the expansion stage of operation, respectively.

17. A compressed air energy storage (CAES) system alternately operable in a compression mode and an expansion mode, the CAES system comprising:
a combined motor-generator unit configured to both generate mechanical power and electrical power;
a drive shaft connected to the motor-generator unit and configured to transmit rotational power to and from the motor-generator unit;
a reversible compressor-expander unit fixedly coupled to the drive shaft; and
an air storage unit connected to the reversible compressor-expander unit and configured to store compressed air received therefrom;
wherein the reversible compressor-expander unit is coupled to the drive shaft without use of a clutch such that the reversible compressor-expander unit operates to compress air during the compression mode and expand air during the expansion mode.

18. The CAES system of claim 17 wherein the reversible compressor-expander unit is configured to operate as a compressor when driven by the drive shaft during the compression mode of operation.

19. The CAES system of claim 17 wherein the reversible compressor-expander unit is configured to operate as an expander when supplied with compressed air from the air storage unit.

20. The CAES system of claim 17 wherein the reversible compressor-expander unit comprises one of a radial-type compressor-expander unit, an axial-type compressor-expander unit, a screw-type compressor-expander unit, and a piston-type compressor-expander unit.

21. The CAES system of claim 17 comprising at least one additional reversible compressor-expander unit, such that the reversible compressor-expander unit and the at least one additional reversible compressor-expander unit form a multi-stage air compression and expansion system.
